(19) United States
(12) Patent Application Publication
(10) Pub. No.: US 2016/0267409 A1
(43) Pub. Date: Sep. 15, 2016

(54) METHODS FOR IDENTIFYING RELATED CONTEXT BETWEEN ENTITIES AND DEVICES THEREOF

(71) Applicant: Wipro Limited, Bangalore (IN)

(72) Inventors: Rinku Vatnani, Indore (IN); Akash Gupta, Jaipur (IN); Vinay Kumar, Bangalore (IN)

(21) Appl. No.: 14/742,095

(22) Filed: Jun. 17, 2015

(30) Foreign Application Priority Data
Mar. 10, 2015 (IN) 1172/CHE/2015

(51) Int. Cl. G06Q 10/06

(52) U.S. Cl. CPC G06Q 10/0637

(57) ABSTRACT

A method, non-transitory computer readable medium, and a data management computing device that assists with identifying relationship between entities includes including obtaining heterogeneous data associated with two or more primary entities from one or more data sources. Only relevant data associated with the two or more primary entities is identified from the obtained heterogeneous data. A masked relationship between the two or more primary entities is determined based on the identified relevant data and a generated entity relationship mapping. A related context for the determined masked relationship between the two or more primary entities are identified and provided.

This application claims the benefit of Indian Patent Application Filing 1172/CHE/2015, filed Mar. 10, 2015, which is hereby incorporated by reference in its entirety.

### FIELD

This technology generally relates to data management, more particularly, to methods for identifying related context between entities and devices thereof.

### BACKGROUND

Researching an entity or other organization is a common and recurring activity in most businesses. Often, researching the entity or organization also includes identifying relationship between the entity and the organization. By way of example, a financial organization, such as a bank, would want to know the relationship between the board-of-directors of the bank and the board-of-directors of the company which is the client of the bank to ensure adherence to KYC/AML norms. Accordingly, identifying relationship between entities involves identifying the entity's ownership structure, beneficiaries and controlling structure, organizational hierarchy, key persons of interest and the relationships between them among many others. However, the problem faced in the above illustrated scenarios is that these relationships between entities of interest are often not explicit, hard to establish, are often masked in layers of noisy, unstructured and disparate data sources. Existing knowledge bases are built on limited set of data sources and are only capable of identifying explicitly defined relationships. Unfortunately, problems faced by the existing technologies also include failure to automatically extraction of the complete entity context from multiple heterogeneous sources. Additionally, existing technologies requires manually searching for relationship between entities and these techniques report significant number of errors or may not identifies all possible relationship between entities due to the vast amount of data.

### SUMMARY

A method for identifying relationship between entities includes obtaining, by a data management computing device, heterogeneous data associated with two or more primary entities from one or more data sources. Only relevant data associated with the two or more primary entities is identified from the obtained heterogeneous data by the data management computing device. A masked relationship between the two or more primary entities is determined by the data management computing device based on the identified relevant data and a generated entity relationship mapping. A related context for the determined masked relationship between the two or more primary entities are identified and provided by the data management computing device.

A non-transitory computer readable medium having stored thereon instructions for identifying relationship between entities comprising machine executable code which when executed by at least one processor, causes the processor to perform steps including obtaining heterogeneous data associated with two or more primary entities from one or more data sources. Only relevant data associated with the two or more primary entities is identified from the obtained heterogeneous data. A masked relationship between the two or more primary entities is determined based on the identified relevant data and a generated entity relationship mapping. A related context for the determined masked relationship between the two or more primary entities are identified and provided.

A data management computing device comprising a processor, a memory, wherein the memory coupled to the processor which is configured to execute programmed instructions stored in the memory including obtaining heterogeneous data associated with two or more primary entities from one or more data sources. Only relevant data associated with the two or more primary entities is identified from the obtained heterogeneous data. A masked relationship between the two or more primary entities is determined based on the identified relevant data and a generated entity relationship mapping. A related context for the determined masked relationship between the two or more primary entities are identified and provided.

This technology provides a number of advantages including providing more effective methods, non-transitory computer readable medium and devices for identifying related context between entities. Using the techniques disclosed herein, the technology is able to provide information on limited explicitly defined relationships between any two entities. Additionally, the technology uncovers masked or otherwise hidden relationships amongst two entities without the necessity to define the types of relationships. By representing the data using the multi-level graph structure, the technology illustrates multi-level extraction of information related to an entity by associating a weight to every relationship at every level, and measuring the relevance of a relationship along with the identification of the relationship. Additionally, by representing and processing these large amounts of data on a multi-level or a tree data structure, the technology is able to manage the memory of the data management computing device efficiently and thereby increasing the performance of the data management computing device.

### BRIEF DESCRIPTION OF THE DRAWINGS

FIG. 1 is a block diagram of an exemplary data management computing device for identifying related context between entities;

FIG. 2 is an exemplary functional block diagram of the data management computing device;

FIG. 3 is an exemplary data flow diagram of the modules within a memory of the data management computing device;

FIG. 4 is an exemplary flowchart illustrating a method for identifying related context between entities based on hierarchies of relationships;

FIG. 5 is an exemplary flowchart illustrating a method for determining entity relationship using n-level knowledge extraction; and

FIG. 6 is an exemplary graphical representation of entity relationships.

### DETAILED DESCRIPTION

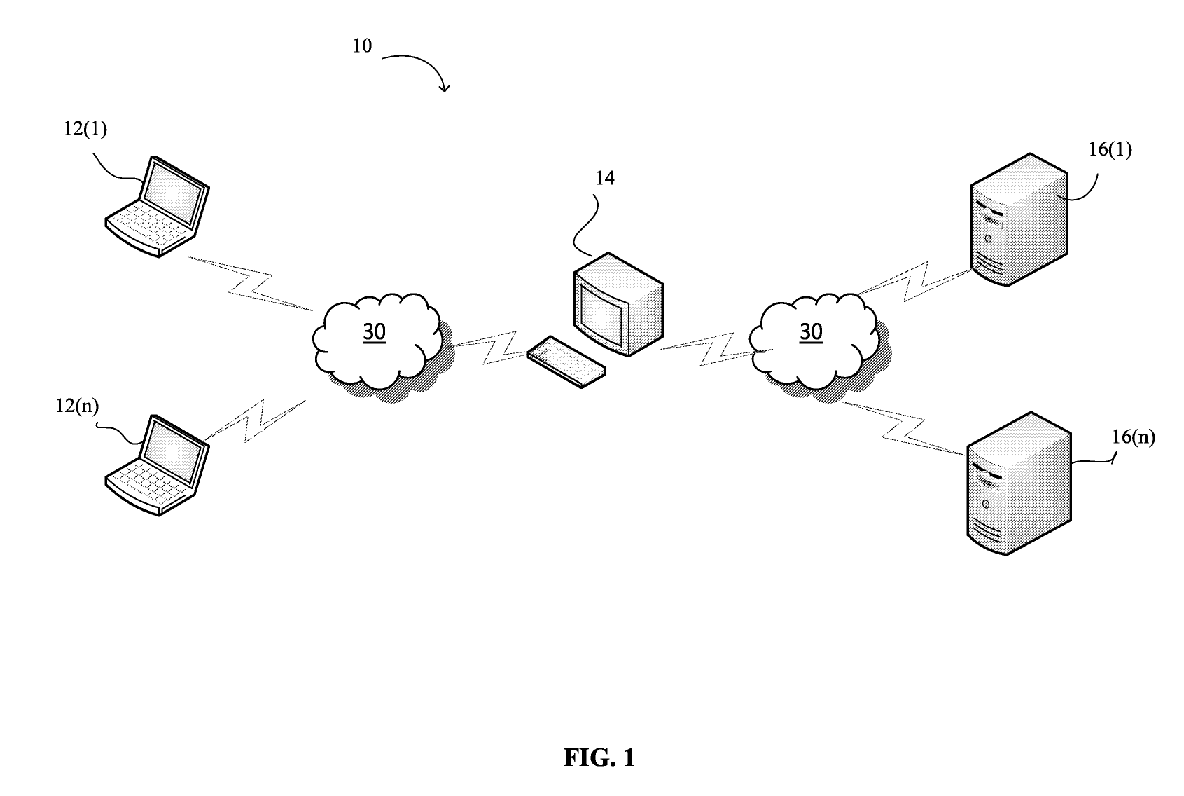

An exemplary environment 10 including a plurality of client computing devices 12(1)-12(n), a data management computing device 14 and a plurality of data sources 16(1)-16(n) for identifying related context between entities is illustrated in FIG. 1. The exemplary environment 10 includes plurality of client computing devices 12, the data management computing device 14, and which are coupled together by a communication network 30, although the environment can include other types and numbers of devices, components, elements, and communication networks 30 in other topologies and deployments. While not shown, the exemplary environment 10 may include additional components, such as database etc, which are well known to those of ordinary skill in the art and thus will not be described here. This technology provides a number of advantages including providing more effective methods, non-transitory computer readable medium and devices for identifying related context between entities.

The data management computing device 14 assists with identifying related context between entities as illustrated and described with the examples herein, although data management computing device 14 may perform other types and numbers of functions. The data management computing device 14 includes at least one CPU/processor 18, memory 20, input device 22A and display device 22B, and interface device 24 which are all coupled together by bus 26, although data management computing device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

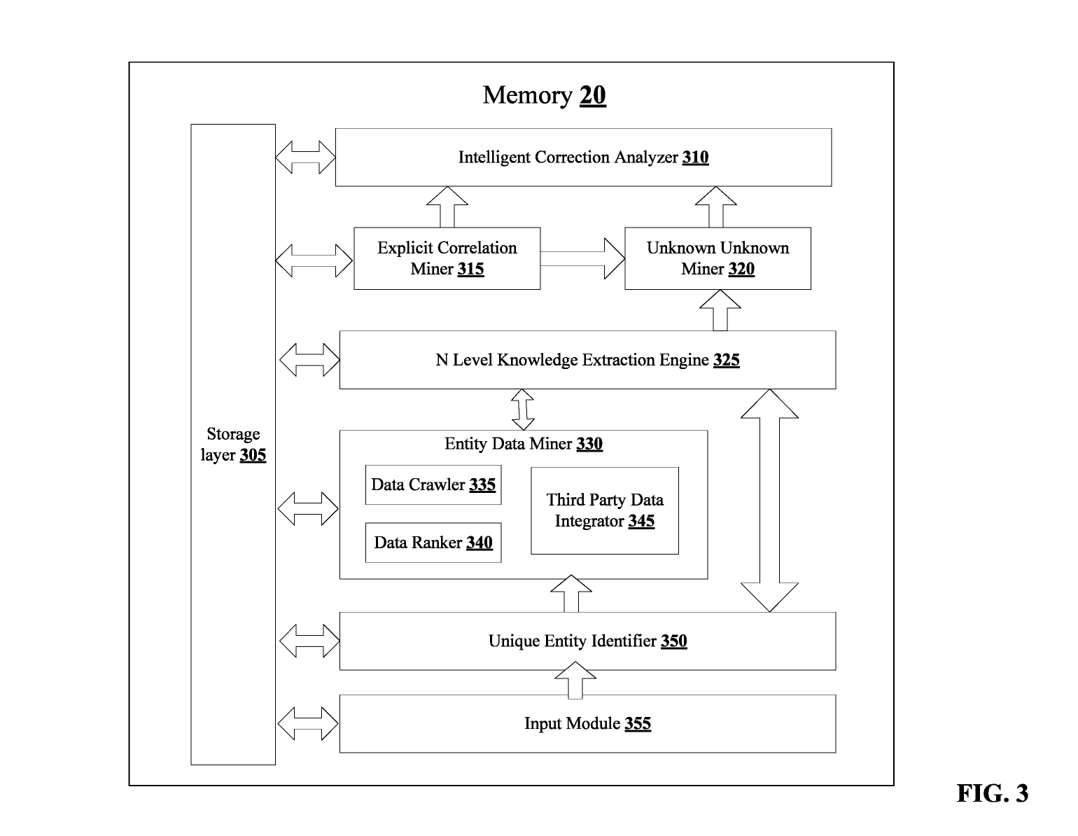

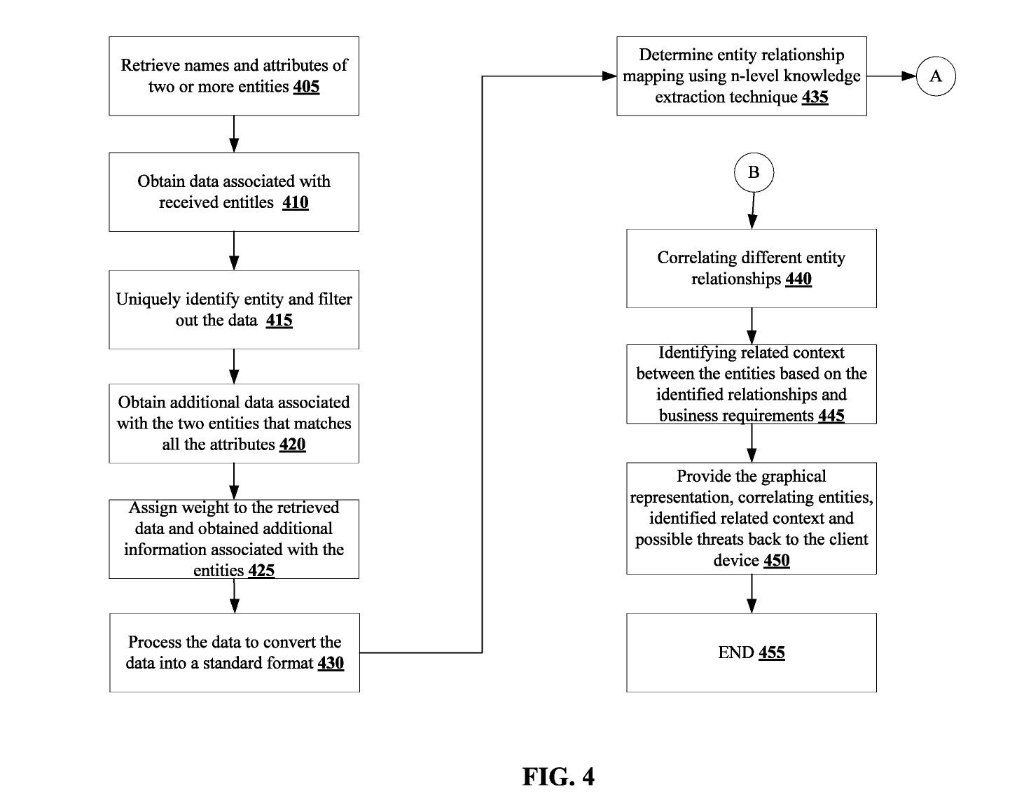

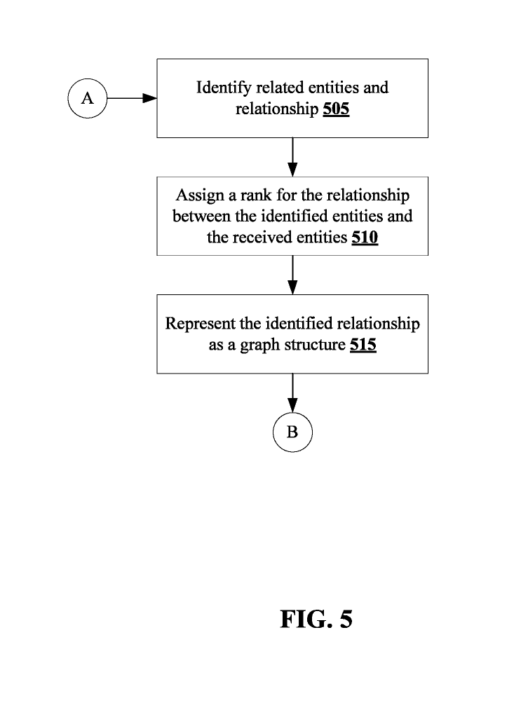

Memory 20 may comprise one or more tangible storage media, such as RAM, ROM, flash memory, CD-ROM, floppy disk, hard disk drive(s), solid state memory, DVD, or other memory storage types or devices, including combinations thereof, which are known to those of ordinary skill in the art. Memory 20 may store one or more non-transitory computer-readable instructions of this technology as illustrated and described with reference to the examples herein that may be executed by the one or more processor(s) 18. The flow chart shown in FIGS. 4-5 is representative of example steps or actions of this technology that may be embodied or expressed as one or more non-transitory computer or machine readable instructions stored in memory 20 that may be executed by the processor(s) 18. Additionally, as illustrated in FIG. 3, memory 20 includes a storage layer 305, intelligent correction analyzer 310, explicit correlation miner 315, unknown-unknown miner 320, N level knowledge extraction engine 325, an entity data miner 330 including data crawler 335, data ranker 340 and third party data integrator 345, unique entity identifier 350 and input module 355, although the memory 20 can include other types of modules.

In this example, the storage layer 305 stores input, processed, analyzed data, graph data structure for each entity, correlation results, although storage layer 305 can include other types or amounts of information. Additionally in this example, the storage layer 305 can store information such as keyword generated, taxonomy used for the location, crawled data, images, videos of entity and locations to assist with assists with identifying related context between entities based on hierarchies of relationships.

Next, the intelligent correction analyzer 310 in this example assists with providing valuable business insights depending upon business case, although the intelligent correction analyzer 310 can assists with other types or amounts of functions. By way of example only, if director of company A is also owner of company B and if there is a transaction between company A and B then there is a conflict of interest.

Next, the explicit correlation miner 315 in this example assists with identifying the content explicitly related with a plurality of entities, although the explicit correlation miner 315 can assists with other types or amounts of functions. In this example, the data related to both the entities is obtained by performing data crawling, although the data related to both the entities can be obtained using other techniques. Additionally, in this example, the correlation results are used to further enrich the correlation information.

The unknown-unknown miner 320 in this example assists with mining the correlation between different entities mentioned in input module 355 by analyzing and correlating their individual graph data structures created by N-level knowledge extraction engine 325, although the unknown-unknown 320 can perform other types of functions.

Next, while not shown in FIG. 3, the N level knowledge extraction engine 325 in this example further includes sub-modules such as a data preprocessor, related entity extractor, relationship ranker, entity attribute enricher and a graph data populater, although the N level knowledge extraction engine 325 can include other types of sub-modules. By way of example only, the data preprocessor sub module assists with extracting data from different type of data points such as portable document format (PDF), word document, videos, although the data preprocessor sub module can extract data from other types of data points. Additionally, the data preprocessor sub module can convert the extracted data into a format suitable for processing. Further, once the data is converted the data preprocessor sub module performs preprocessing on text data by filtering and cleaning after performing various transformations like lower case conversion, URL removal, stop word removal, stemming, deduplication, or special character removal etc. By way of example, the data preprocessor module performs preprocessing on the videos by converting the videos into frames. Next the related entity extractor sub module is used for identifying entities related with input entity by performing text and video analytics on the pre-processed data. Further, the relationship ranker is a sub-module that assists with ranking the related entities on the basis of importance of their relationships as well as confidence score provided in Data Ranker sub-module 340. Next, the entity attribute enricher sub module assists with extracting the various attributes about the entity such as interests, demographic features by analyzing data through text analytics techniques like topic modelling, trending topic detection, taxonomy, although the entity attribute enricher sub module can assist with extracting other types of attributes using other types of text analytics. Additionally, the graph data populator sub-module assists with populating the analyzed data into a graph like data structure, although the graph data populator sub-module can represent the data in other formats. In this example, the nodes indicate the related entities and the thickness of connection indicates the relationship strength on the basis of relationship ranker.

Next, the memory 20 includes an entity data miner 330 which further includes sub-modules such as a data crawler 335, data ranker 340 and a third party data integrator 345, although the entity data miner 330 can include other types or amounts of sub-modules. The data crawler 335 assists with crawling and fetching entity related data points using a list of explicit sources as well implicit sources, on the basis of different taxonomies, although the data crawler 335 can perform other types or amounts of functions. By way of example only, the explicit sources are specified by the input module 355 and include a list of websites, blogs, portals, public directories related to the domain of the entity can be explicitly specified and connectors to the source are used to extract the entity information, although explicit sources can include other types or amounts of information. By way of example only, a Bank may specify SEC or Watch Lists as the explicit sources for investigating relationships between two companies. Additionally in this example, an implicit sources includes sources which are not entity specific and are more generic kind of data sources and is scraped is using Google search API and a query generator which works on the basis of different taxonomies for different use cases. For purpose of further illustration, publicly available web data represents an implicit source. Next the data ranker 335 is a sub-module that assists with ranking each entity data point on the basis of authenticity or relevance of the data source, date of publishing, although the data ranker 335 can consider other types or amounts of parameters. In this example, the data ranker 335 also assists in determining weightage given to information extracted in the rest of the modules during processing. Finally, the third party data integrator 345 is a sub-module that assists with integrating any privately available data source with third party for extracting information about an entity, although the third part data integrator 345 can perform other types or amounts of operations.

Next, the unique entity identifier 350 assists with analyzing information provided for each entity is and used to uniquely identify the entity within each data source available to the system, although the unique entity identifier 350 can assists with performing other types or amounts of functions. In this example, the initial known attributes specified as input are used to identify an entity within each data source and upon a sure identification, further enrichment of attributes results from the data source. By way of example, if user provides name and location of the entity, then there is a possibility of multiple entities having same attributes. Additionally, in this example, the unique entity identifier 350 also assists with determining the entity intended by the user by providing a list of entities having same information.

Finally the input module 355 in this example assists with naming of the entities along-with the known attributes for the entity is specified to the system by the user, although the input module 355 can perform other types or amounts of functions. In this example, the plurality of client computing devices 12(1)-12(n) also provides the kind of sources to be used for determining the relationships between the multiple entities.

Input device 22A enables a user, such as a programmer or a developer, to interact with the data management computing device 14, such as to input and/or view data and/or to configure, program and/or operate it by way of example only. By way of example only, input device 22A may include one or more of a touch screen, keyboard and/or a computer mouse.

The display device 22B enables a user, such as an administrator, to interact with the data management computing device 14, such as to input and/or view data and/or to configure, program and/or operate it by way of example only. By way of example only, the display device 22B may include one or more of a CRT, LED monitor, or LCD monitor, although other types and numbers of display devices could be used.

The interface device 24 in the data management computing device 14 is used to operatively couple and communicate between the data management computing device 14, the plurality of client computing devices 12(1)-12(n) and the plurality of data sources 16(1)-16(n), although other types and numbers of systems, devices, components, elements and/or networks with other types and numbers of connections and configurations can be used. By way of example only, the data management computing device 14 can interact with other devices via a communication network 30 such as Local Area Network (LAN) and Wide Area Network (WAN) and can use TCP/IP over Ethernet and industry-standard protocols, including NFS, CIFS, SOAP, XML, LDAP, and SNMP, although other types and numbers of communication networks, can be used. In this example, the bus 26 is a hyper-transport bus in this example, although other types of buses and/or other links may be used, such as PCI.

Each of the plurality of client computing devices 12(1)-12(n) includes a central processing unit (CPU) or processor, a memory, an interface device, input device and display device, which are coupled together by a bus or other link, although each could have other types and numbers of elements and/or other types and numbers of network devices could be used in this environment. The client computing device 12(1)-12(n), in this example, may run interface applications that may provide an interface to request for identifying related context between entities based on hierarchies of relationships.

The network environment 10 also includes plurality of data sources 16(1)-16(n). Each of the plurality of data sources 16(1)-16(n) includes a central processing unit (CPU) or processor, a memory, an interface device, and an I/O system, which are coupled together by a bus or other link, although other numbers and types of network devices could be used. Each of the plurality of data sources 16(1)-16(n) communicate with the data management computing device 14 through communication network 30, although the plurality of data sources 16(1)-16(n) can interact with the data management computing device 14 by other techniques. Various network processing applications, such as CIFS applications, NFS applications, HTTP Web Server applications, and/or FTP applications, may be operating on the plurality of data sources 16(1)-16(n) and transmitting content (e.g., files, Web pages) to the plurality of client computing devices 12(1)-12(n) or the data management computing device 14 in response to the requests.

It is to be understood that the methods of the examples described herein are for exemplary purposes, as many variations of the specific hardware and software used to implement the examples are possible, as will be appreciated by those skilled in the relevant art(s).

Furthermore, each of the methods of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as then the non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

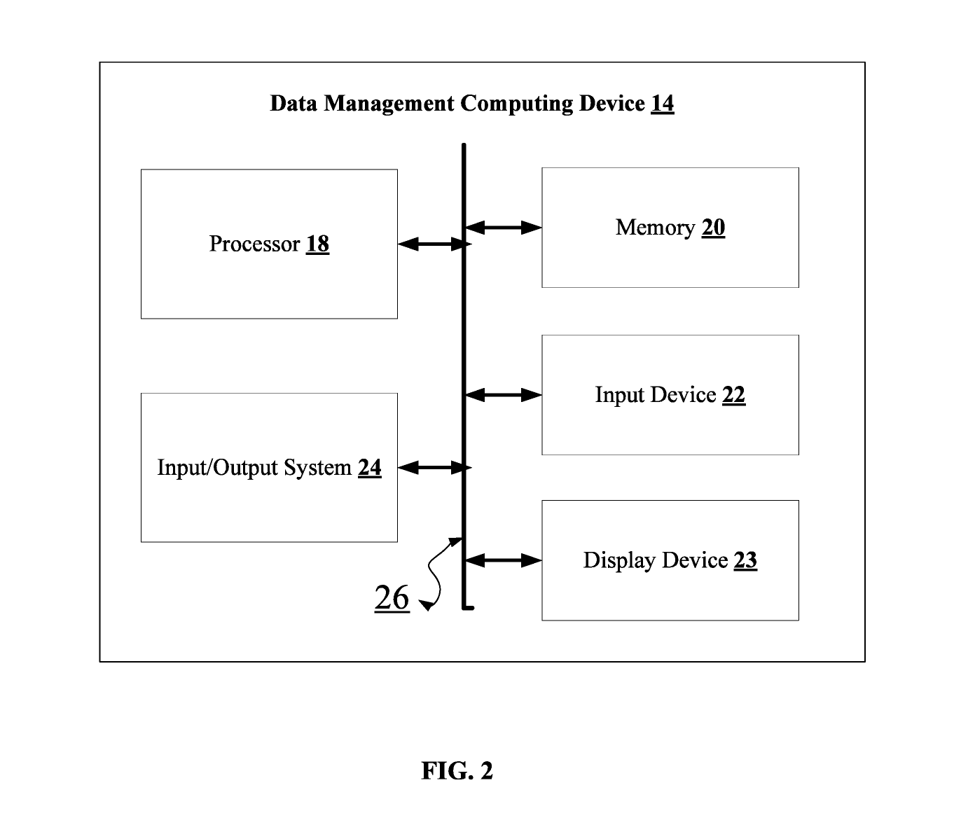

An exemplary method for identifying related context between entities will now be described with reference to FIGS. 1-6. This example begins at step 405 where the data management computing device 14 receives names of two or more primary entities and attributes associated with the two or more primary entities from one of the plurality of client computing devices 12(1)-12(n), although the data management computing device 14 can obtain other types or amounts of information from the plurality of client computing devices 12(1)-12(n). In this example, primary entities relates to a person, organization, although entities can also include any other type or amounts of information. Additionally in this example, attributes relates to data that further illustrates and defines the entities. By way of example, the data management computing device 14 receives name of a person and name of a financial organization and attributes associated with the person such as work title of person, hobbies, personal interests, financial investments, education background, tax filings associated with the financial organization, SEC filings of the financial organization from the requesting one of the plurality of client computing devices 12(1)-12(n), although the data management computing device 14 can obtain other types or amounts of attributes from the requesting one of the plurality of client computing devices 12(1)-12(n). Alternatively, the data management computing device 14 can receive name and attributes of one entity and then list of plurality of entities for which the relationship with the one entity is required to be identified. By way of example, the data management computing device can receive name of a person and a list of financial organizations for which the relationship of the person to each of the financial organization is required to be identified.

In step 410, the data management computing device 14 retrieves data associated with the received names of the two or more primary entities from heterogeneous data sources such as plurality of data sources 16(1)-16(n), although the data management computing device 14 can obtain the data associated with the received names of the two or more primary entities from other types of data sources. By way of example only, the data retrieved from the plurality of data sources 16(1)-16(n) includes data from websites, although the data management computing device 14 can also retrieve from a third party list of data sources from the requesting one of the plurality of client computing devices 12(1)-12(n). In this example, the data management computing device 14 retrieves all types and amounts of data that matches with the names of the two or more entities from the plurality of data sources 16(1)-16(n).

Next in step 415, the data management computing device 14 filters out the retrieved data in step 410 using the received attributes associated with the two or more primary entities to uniquely identify the actual data associated the received names of the two or more entities, although the data management computing device 14 can use other types of parameters to filter the retrieved data. In this example, the data management computing device 14 only retains the data associated with the received two or more entities that matches with all the attributes of the two or more entities and filters out the rest of the data. By way of example, there can be multiple people having the same name of the entity that was received in step 405 and the data associated with these multiple people having the same full name of the received entity can be easily filtered out by the data management computing device 14 by retaining only the data that matches with all the received attributes associated with the entity. In this example, the data management computing device 14 uses attributes of the name of the person such as work title, financial investments, and educational background associated with the received name of the person to filter out the redundant data and uniquely identify the entity. Additionally, the data management computing device 14 uses attributes of the financial organization such as financial investments, tax filings associated with the financial organization, and SEC filings of the financial organization to filter out the redundant data and uniquely identify the received name of financial organization (an entity).

In step 420, the data management computing device 14 obtains additional information associated with the two or more primary entities that matches with all the received attributes from the plurality of data sources 16(1)-16(n), although the data management computing device 14 can obtain additional information from other locations. By way of example, the additional information obtained from the plurality of data sources 16(1)-16(n) includes data from implicit data sources, explicit data sources and third party data sources. In this example, implicit data sources relates to publicly available web based knowledge sources and explicit data sources relates to domain or entity specific data sources that are specified by a user through the plurality of client computing devices 12(1)-12(n). Additionally in this example, the third party data sources relates to private data sources that is available in the plurality of data sources 16(1)-16(n).

Next in step 425, the data management computing device 14 assigns a first weighted value to each of the obtained data and the retrieved additional information associated with the two or more primary entities. In this example, the data management computing device 14 assigns the first weighted value to each of the obtained data and the retrieved additional information based on the factors such as a type of data source (implicit, explicit or third party data sources), reliability of the data sources, relevance of the data sources to the domain and the time state of the data, although the data management computing device 14 can assign the weighted value based on other parameters. In this example, reliability of the data source relates to the place from which the data obtained associated with the entity is obtained. By way of example, data obtained from a company's website for the name of the person is more reliable than the data obtained from a third party blog. Next in this example, relevance of the data source to the domain relates to the context in which the relationship between the two or more primary entities is being established. By way of example, data associated with a common geographical location of the financial organization and the name of a person may be less relevant while investigating anti-money laundering in the financial organization with the name of the entity (person). Lastly, time state of the data in this example relates to the time and data at which the data was published. By way of example, a recently updated or published data will have a higher relevancy over old or previous versions of the data. Accordingly, in this example the data management computing device 14 assigns the first weighted value to each of the data based on the parameters listed above. By way of example, an implicit data source which has relevant domain data obtained from the website that is recently published will have a higher weighted value when compared to data obtained from a third party data sources which has non-relevant data obtained from a third party blog that was published five years back. Additionally in this example, the first weighted value assigned by the data management computing device 14 is a numerical value between one to ten, one being the lowest weighted value and ten being the highest weighted value, although in another example, one can be the highest weighted value and ten can be the lowest weighted value.

Next in step 430, the data management computing device 14 processes each of the data associated with the two or more entities that have been assigned with the weighted value to convert the data to a standard format for further processing. By way of example, raw text data is parsed and extracted from the documents and webpages. Additionally, images and portable document format documents are converted to textual data and special characters, irrelevant or common words are extracted as part of processing each of the data. Furthermore, the video data is converted into frames of images and then tagged with associated meta-data, although the data management computing device 14 can perform other steps as part of processing of data.

Next in step 435, the data management computing device 14 determines an entity relationship mapping using n-level knowledge extraction technique which will be further illustrated with reference to an exemplary flowchart in FIG. 5. In step 505 of FIG. 5, the data management computing device 14 identifies related entities from the processed data of illustrated in step 430 by first performing a textual analysis and a video analysis, although the data management computing device 14 can perform other types or amounts of analysis on the processed data. In this example, the data management computing device 14 performs textual analysis by first extracting all the entities in the processed data using entity recognition algorithms which are easily identifiable by a person having ordinary skill in the art and which is hereby incorporated by its reference in its entirety, although the data management computing device 14 can perform other types or amounts of algorithms to extracted all the entities from the processed data. Next, each of the extracted entity from the textual data is assigned with a correlation score based on techniques such as distance based correlation, taxonomy matching, PMI correlation, which are all incorporated herein in its entirety. Additionally, a relevance score is also assigned to each of the extracted entities from the processed data by comparing received two or more input entities. By way of example, a higher relevance score is assigned to each of the extracted entity when is relevant and a lower relevance score is assigned to each of the extracted entity when the extracted entity is not relevant. As previously illustrated, the relevance score and the correlation score is a numerical value ranging between zero and ten, where zero is the least relevant value and ten being the most relevant value. Additionally, the data management computing device 14 establishes the relevancy based on the received attributes of the received two or more entities and the attributes of the extracted entities, although the data management computing device 14 can use other types or amounts of information to establish a relevancy between the received two or more entities from the plurality of client computing devices 12(1)-12(n) and the extracted entities from the processed data. Similar to the textual analysis, the data management computing device performs a video analysis of the processed data and assigns a correlation score using techniques illustrated above to each of the video data. By way of example, the data management computing device 14 assigns a low correlation score and lower relevance score when no relationship is found between the two entities in the video context.

Next in step 510, the data management computing device 14 assigns a rank to each of the identifies relationship between the two or more entities and the extracted entities based on the correlation score assigned in the step 505 and the first weighted value assigned in step 425 for each of the data associated with the two or more entities. By way of example only, the memory 20 of the data management computing device 14 includes a table that includes a rank for the corresponding combination of the correlation score and the first weighted value. Upon assigning the rank, the data management computing device 14 enriches by extracting any additional attributes associated with the extracted entities and the received two or more entities, although the data management computing device 14 can enrich the identified relationship using other techniques.

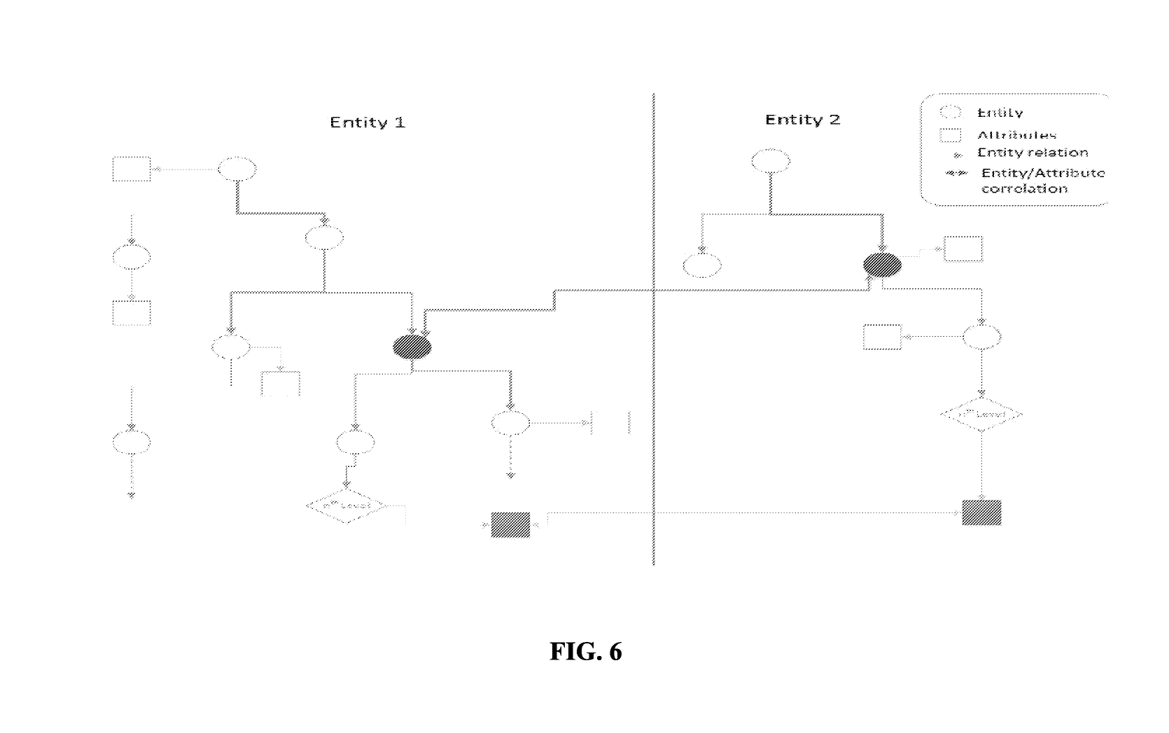

In step 515, the data management computing device 14 represents the identified relationship between the received two or more entities and the extracted entities and their rankings in form of a graph data structure, although the data management computing device 14 can represent the data using other types of data structure. In this example, all the entities are represented as nodes in the graph and the attribute information about each entity is stored within the node. Further, edges between nodes represent relationships between entities and the weight assigned to each relationship determines the thickness of an edge between two nodes. By way of example, FIG. 6 illustrates the graphical representation of the relationship between the entities. Now the exemplary flow proceeds back to FIG. 4.

In step 440 of FIG. 4, the data management computing device 14 correlates the different entity relationships by first identifying common related entities in the relationship maps and then identifying the common attributes between them, although the data management computing device 14 can use other techniques to correlate the different entity relationships. In this example, the data management computing device 14 identifies common related entities in the relationship maps illustrated in FIG. 6 and identifies the common attributes by ranking each commonality (an entity or attribute) individually based on the hierarchal distance of the entity from the initial node, and the weight of the relationship represented by the graph edge. Using this technique, the technology disclosed herein is able to identify the masked (hidden or unknown) hierarchal relationships between the initial entities and the extracted entities. Alternatively, in another example, another level of explicit relationship between the two entities can be known by searching for a joint occurrence of the two entities in a data document that includes textual data of the graphical representation illustrated in FIG. 6.

In step 445, the data management computing device 14 identifies related context between the entities based on the identified relationships and one or more business requirements, although the data management computing device 14 can identify the related context using other types or amounts of parameters. In this example, memory 20 of the data management computing device 14 includes business rules pre-defined for the use-case and these pre-defined business rules can be used to interpret the relationships between the entities. By way of example only, for a use-case of establishing connections between two companies for anti-money laundering checks, the final risk of a transaction between the two companies is derived based on the common entities, common attributes and the strength of relationships derived for the two entities. One example of a pre-defined business rule for this domain can be reporting a AML threat when there are strong relationships observed between the people owning the two companies. For purpose of further illustration of this business rule, consider company A is related to person P1 by the relationship of being a board of director for the company. Similarly, person P2 is a board of director in company B. Additionally, P1 is a brother of P2. Accordingly, based on the business rule, the correlation between the companies A and B is flagged as a possible risk for a transaction between the two companies.

Next in step 450, the data management computing device 14 provides the graphical representation illustrated in FIG. 6, information associated with the correlating entities, the context identified in step 445 and any possible threats back to the requesting one of the plurality of client computing devices 12(1)-12(n), although the data management computing device 14 can provide other types or amounts of information. The exemplary method ends at step 455.

Accordingly, as illustrated and described by way of the examples herein this technology provides more effective methods, non-transitory computer readable medium and devices for identifying related context between entities. Using the techniques disclosed herein, the technology is able to provide information on limited explicitly defined relationships between any two entities. Additionally, the technology uncovers masked or otherwise hidden relationships amongst two entities without the necessity to define the types of relationships. By representing the data using the multi-level (hierarchical) graph structure, the technology illustrates multi-level extraction of information related to an entity by associating a weight to every relationship at every level, and measuring the relevance of a relationship along with the identification of the relationship. Additionally, by representing and processing these large amounts of data on a muti-level or a tree data structure, the technology is able to manage the memory of the data management computing device efficiently and thereby increasing the performance of the data management computing device.

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations therefore, is not intended to limit the claimed processes to any order except as may be specified in the claims. Accordingly, the technology is limited only by the following claims and equivalents thereto.

What is claimed is:

1. A method for identifying relationship between entities, the method comprising:
obtaining, by a data management computing device, heterogeneous data associated with two or more primary entities from one or more data sources;
identifying, by the data management computing device, only relevant data associated with the two or more primary entities from the obtained heterogenous data;
determining, by the data management computing device, a masked relationship between the two or more primary entities based on the identified relevant data and a generated entity relationship mapping; and
identifying and providing, by the data management computing device, a related context for the determined masked relationship between the two or more primary entities.

2. The method as set forth in claim 1 further comprising:
obtaining, by the data management computing device, one or more attributes associated with the two or more primary entities;
obtaining, by the data management computing device, additional information associated with the two or more primary entities based on the obtained one or more attributes;
identifying, by the data management computing device, the only relevant data associated with the two or more primary entities from the obtained heterogenous data and the obtained additional information when the obtained heterogenous data matches with each of the obtained one or more attributes associated with the two or more primary entities; and
assigning, by the data management computing device, a weighted value for identified relevant data associated with the two or more primary entities based on a type of data source, a reliability factor of the one or more data sources, a relevance score of the one or more data sources to a domain and a time state of the one or more data sources.

3. The method as set forth in claim 2 further comprising:
identifying, by the data management computing device, one or more additional entities from the only relevant data associated with the two or more primary entities; and
identifying, by the data management computing device, an entity relationship between the identified one or more additional entities and the two or more primary entities.

4. The method as set forth in claim 3 further comprising:
assigning, by the data management computing device, a correlation score by comparing the identified one or more additional entities and the two or more primary entities; and
assigning, by the data management computing device, a rank for the identified entity relationship based on the assigned correlation score and the assigned weighted value.

5. The method as set forth in claim 4 further comprising generating, by the data management computing device, the entity relationship mapping between the two or more primary entities and the identified one or more additional entities based on the assigned rank.

6. The method as set forth in claim 1 wherein the identifying and providing further comprises identifying, by the data management computing device, the related context in the determined relationship between the two or more entities based on one or more business requirements.

7. A data management computing device comprising:
a processor;
a memory, wherein the memory coupled to the processor which are configured to execute programmed instructions stored in the memory comprising:
obtaining heterogeneous data associated with two or more primary entities from one or more data sources;
identifying only relevant data associated with the two or more primary entities from the obtained heterogenous data;
determining a masked relationship between the two or more primary entities based on the identified relevant data and a generated entity relationship mapping; and
identifying and providing a related context for the determined masked relationship between the two or more primary entities.

8. The device as set forth in claim 7 wherein the processor is further configured to execute programmed instructions stored in the memory further comprising:
obtaining one or more attributes associated with the two or more primary entities;
obtaining additional information associated with the two or more primary entities based on the obtained one or more attributes;
identifying only relevant data associated with the two or more primary entities from the obtained heterogenous data and the obtained additional information when the obtained heterogenous data matches with each of the obtained one or more attributes associated with the two or more primary entities; and
assigning a weighted value for identified relevant data associated with the two or more primary entities based on a type of data source, a reliability factor of the one or more data sources, a relevance score of the one or more data sources to a domain and a time state of the one or more data sources.

9. The device as set forth in claim 8 wherein the processor is further configured to execute programmed instructions stored in the memory further comprising:
identifying one or more additional entities from the identified the only relevant data associated with the two or more primary entities; and
identifying an entity relationship between the identified one or more additional entities and the two or more primary entities.

10. The device as set forth in claim 9 wherein the processor is further configured to execute programmed instructions stored in the memory further comprising:
assigning a correlation score by comparing the identified one or more additional entities and the two or more primary entities; and
assigning a rank for the identified entity relationship based on the assigned correlation score and the assigned weighted value.

11. The device as set forth in claim 10 wherein the processor is further configured to execute programmed instructions stored in the memory further comprising generating the entity relationship mapping between the two or more primary entities and the identified one or more additional entities based on the assigned rank.

12. The device as set forth in claim 7 wherein the processor is further configured to execute programmed instructions stored in the memory for the identifying and providing further comprises identifying, by the data management computing device, the related context in the determined relationship between the two or more entities based on one or more business requirements.

13. A non-transitory computer readable medium having stored thereon instructions for identifying relationship between entities comprising machine executable code which when executed by at least one processor, causes the processor to perform steps comprising:
obtaining heterogeneous data associated with two or more primary entities from one or more data sources;
identifying only relevant data associated with the two or more primary entities from the obtained heterogenous data;
determining a masked relationship between the two or more primary entities based on the identified relevant data and a generated entity relationship mapping; and
identifying and providing a related context for the determined masked relationship between the two or more primary entities.

14. The medium as set forth in claim 13 further comprising:
obtaining one or more attributes associated with the two or more primary entities;
obtaining additional information associated with the two or more primary entities based on the obtained one or more attributes;
identifying only relevant data associated with the two or more primary entities from the obtained heterogenous data and the obtained additional information when the obtained heterogenous data matches with each of the obtained one or more attributes associated with the two or more primary entities; and
assigning a weighted value for identified relevant data associated with the two or more primary entities based on a type of data source, a reliability factor of the one or more data sources, a relevance score of the one or more data sources to a domain and a time state of the one or more data sources.

15. The medium as set forth in claim 14 further comprising:
identifying one or more additional entities from the identified the only relevant data associated with the two or more primary entities; and
identifying an entity relationship between the identified one or more additional entities and the two or more primary entities.

16. The medium as set forth in claim 15 further comprising:
assigning a correlation score by comparing the identified one or more additional entities and the two or more primary entities; and
assigning a rank for the identified entity relationship based on the assigned correlation score and the assigned weighted value.

17. The medium as set forth in claim 16 further comprising generating the entity relationship mapping between the two or more primary entities and the identified one or more additional entities based on the assigned rank.

18. The medium as set forth in claim 13 wherein the identifying and providing further comprises identifying, by the data management computing device, the related context in the determined relationship between the two or more entities based on one or more business requirements.
